(19) United States
(12) Patent Application Publication
(10) Pub. No.: US 2023/0211796 A1
(43) Pub. Date: Jul. 6, 2023

(54) METHOD FOR PROVIDING TUNING PROGRESS INFORMATION, METHOD FOR MANAGING TUNING TASK, AND METHOD FOR MANAGING TUNING TASK QUALITY

(71) Applicant: JMWAVE, Seoul (KR)

(72) Inventor: Jeong Min PARK, Gimpo-si (KR)

(21) Appl. No.: 18/071,096

(22) Filed: Nov. 29, 2022

(30) Foreign Application Priority Data
Dec. 31, 2021 (KR) 10-2021-0194493

(51) Int. Cl. B60W 50/08; B60W 50/10; B60W 50/14

(52) U.S. Cl. CPC B60W 50/085; B60W 50/10; B60W 50/14; B60W 2050/146

(57) ABSTRACT

Provided are methods for providing tuning progress information; managing a tuning task; and managing tuning task quality, when tuning an internal combustion engine vehicle to an electric powered vehicle.

The method for providing tuning progress information includes: receiving information related to a tuning target vehicle from a customer terminal; specifying a tuning target vehicle from the received information; specifying tuning target parts for the tuning target vehicle; specifying an agent terminal performing tuning for the specified tuning target vehicle; receiving progress information related to tuning progress details from the specified agent terminal; classifying the tuning target parts into a first component for which tuning has been completed, a second component for which tuning is in progress, and a third component for which tuning has not been started, based on the received progress information; and displaying the components with different display features on a display.

### CROSS REFERENCE TO RELATED APPLICATIONS

This application claims priority to and the benefit of Korean Patent Application No. 10-2021-0194493 filed in the Korean Intellectual Property Office on Dec. 31, 2021, the entire contents of which are incorporated herein by reference.

### TECHNICAL FIELD

The present disclosure relates to a method for providing tuning progress information, a method for managing a tuning task, and a method for managing tuning task quality, when tuning an internal combustion engine vehicle to an electric powered vehicle.

### BACKGROUND

Recently, while the industry using eco-friendly energy is rapidly growing, electric vehicles related thereto are becoming an issue in the automobile industry as well.

Conventional automobiles generally use a method of obtaining energy through an internal combustion engine, i.e., a method of driving the vehicle through an engine using oil as a fuel. However, since the internal combustion engine vehicle has low energy efficiency and is the main culprit of environmental destruction such as consuming fossil fuels and emitting fumes, technology related to the electric vehicles driven by electricity is a trend in the spotlight.

However, it is considered that it will take a long time for the electric vehicles to replace the internal combustion engine vehicles while the internal combustion engine vehicles are widespread. Although it is possible to sell a new electric vehicle, for example, if an existing internal combustion engine vehicle is tuned and converted to an electric vehicle, the spread of the electric vehicles can be accelerated.

Therefore, in tuning an internal combustion engine vehicle to an electric powered vehicle, it is required to develop a management method for providing progress information and comprehensively managing a tuning task or tuning task quality.

The matters described as the background art above are only for improving the understanding of the background of the present disclosure, and should not be taken as an acknowledgment that they correspond to the prior art already known to those of ordinary skill in the art.

### DOCUMENTS OF RELATED ART

### Patent Document

Korean Patent Publication No. 10-2000-0058353 A

### SUMMARY

In order to solve the above problem, the present disclosure provides a method for providing tuning progress information, a method for managing tuning task, and a method for managing a tuning task quality, using a main server, a customer terminal, and an agent terminal when tuning an internal combustion engine vehicle to an electric powered vehicle.

A method for providing tuning progress information according to the present disclosure for achieving the above object includes: receiving information related to a tuning target vehicle from a customer terminal; specifying a tuning target vehicle from the received information; specifying tuning target parts for the tuning target vehicle; specifying an agent terminal performing tuning for the specified tuning target vehicle; receiving progress information related to tuning progress details from the specified agent terminal; classifying the tuning target parts into a first component for which tuning has been completed, a second component for which tuning is in progress, and a third component for which tuning has not been started, based on the received progress information; and displaying the first component, the second component, and the third component with different display features on a display.

The information related to the tuning target vehicle may be at least one of a vehicle number, a vehicle identification number, and owner information.

As for the different display features, the inside of the first component may be displayed in a color-filled state, the inside of the second component may be displayed so that a color-filled state and a transparent state are alternately repeated, and the inside of the third component may be displayed in a transparent state.

Said displaying on a display may be configured to include a mode in which the tuning target vehicle is implemented in a three-dimensional shape when viewed from an external point of view, and a mode in which the tuning target vehicle is implemented in a three-dimensional shape when viewed from an internal point of view.

A method for managing a tuning task according to the present disclosure for achieving the above object includes: transmitting work items to an agent terminal; receiving a work item selected from an agent among the work items from the agent terminal; transmitting To-Do LIST information including the selected work item to the agent terminal; and recording, when information on a completed task in the To-Do LIST information is inputted from the agent terminal, the completed task and transmitting updated To-Do LIST information to the agent terminal.

In the updated To-Do LIST information, a progress level of the work item may be displayed in the form of a traffic light indicating at least one of not in progress and completed.

The method for managing a tuning task may further include: receiving special To-Do LIST information other than the work item from the agent terminal; comparing the special To-Do LIST information with items in a database, in which existing work items are aggregated, to extract an item with high similarity; and transmitting the item with high similarity to the agent terminal, and receiving information on whether to replace the special To-Do LIST information with the item with high similarity.

In said extracting an item with high similarity, similarity determination may be performed by a jacquard similarity measurement method.

The method for managing a tuning task may further include updating the To-Do LIST information to include the special to-do list information, when information that a user has selected that there is no item to be replaced is received in said receiving information on whether to replace the special To-Do LIST information with the item with high similarity.

A method for managing tuning task quality according to the present disclosure for achieving the above object includes: receiving a completed task and corresponding verification information in To-Do LIST from an agent terminal; receiving determination information on whether or not the completed task has been normally performed based on the verification information; generating an updated To-Do LIST based on the determination information, and transmitting it to the agent terminal; and creating shipment instructions when it is determined that all tasks in the To-Do LIST have been completed.

The verification information may be photographic information, and the photographic information may be compared with information in a completed state to calculate similarity, and when the similarity exceeds a preset value, it may be determined that the completed task is normal.

The verification information may be transmitted to a terminal of at least one other agent, determination information on whether or not a corresponding task has been normally completed may be received from the terminal of the at least one other agent, and when the determination information from the terminal of the at least one other agent all indicate normal, it may be determined that the completed task has been normally performed.

A dialogue box may be created between the terminal of the at least one other agent and the agent terminal by a request of the at least one other agent.

In the updated to-do list, a progress level of quality management determination of the completed work may be displayed in the form of a traffic light indicating any one of unchecked, passed, and failed.

According to the method for providing tuning progress information, the method for managing a tuning task, and the method for managing tuning task quality of the present disclosure, when tuning an internal combustion engine vehicle to an electric powered vehicle, a customer, an agent, and a tuning task may be managed comprehensively in the main server, the customer may easily apply for vehicle tuning and check the progress immediately through the customer terminal, and the agent may share the tuning progress between the main server or other agents through the agent terminal.

### BRIEF DESCRIPTION OF DRAWINGS

FIG. 1 is a flowchart of a method for providing tuning progress information according to an embodiment of the present disclosure.

FIG. 2 is a flowchart of a method for managing a tuning task according to an embodiment of the present disclosure.

FIG. 3 is a flowchart of a method for managing tuning task quality according to an embodiment of the present disclosure.

FIG. 4 is a diagram illustrating that a tuning progress information provision method, a tuning task management method, and a tuning task quality management method according to an embodiment of the present disclosure are performed in a main server, a customer terminal, and an agent terminal.

FIGS. 5A and 5B are flowcharts schematically illustrating that a tuning progress information provision method, a tuning task management method, and a tuning task quality management method according to an embodiment of the present disclosure are performed.

FIG. 6 is a diagram schematically illustrating that respective components are displayed on a display with different display features in a tuning progress information provision method according to an embodiment of the present disclosure.

### DETAILED DESCRIPTION

The embodiments described herein may be variously modified. Certain embodiments may be depicted in the drawings and described in detail in the detailed description. However, a specific embodiment disclosed in the accompanying drawings is only provided to facilitate understanding of various embodiments. Therefore, the technical spirit is not limited by the specific embodiment disclosed in the accompanying drawings, and it should be understood to include all equivalents or substitutes included in the spirit and technical scope of the invention.

Terms including an ordinal number such as first, second, and the like may be used to describe various components, but these components are not limited by the above-described terms. The above terms is used only for the purpose of distinguishing one component from another component.

As used herein, terms such as “include” or “have” are intended to designate the existence of features, numbers, steps, operations, components, parts, or combinations thereof described in the specification, and it should be understood that the above terms does not preclude the possibility of addition or existence of one or more other features, or numbers, steps, operations, components, parts, or combinations thereof. When a component is referred to as being “connected” to another component, it is understood that it may be directly connected to the another component, but other components may exist therebetween. On the other hand, when it is mentioned that a component is “directly connected” to another component, it should be understood that other components does not exist therebetween.

Meanwhile, a “module” or “unit” for a component used herein performs at least one function or operation. In addition, the “module” or “unit” may perform a function or operation by hardware, software, or a combination of hardware and software. In addition, a plurality of “modules” or a plurality of “units” other than a “module” or “unit” that needs to be performed in specific hardware or to be executed in at least one processor may be integrated into at least one module. The singular expression includes the plural expression unless the context clearly dictates otherwise.

Further, in describing the present disclosure, if it is determined that a detailed description of a related known function or configuration may unnecessarily obscure the gist of the present disclosure, the detailed description thereof will be abbreviated or omitted.

Hereinafter, various embodiments will be described in more detail with reference to the accompanying drawings.

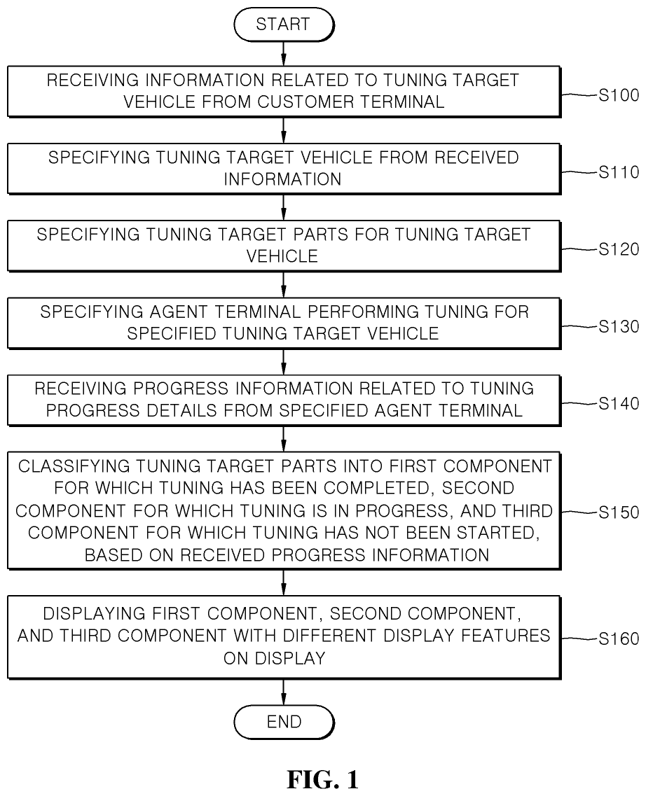

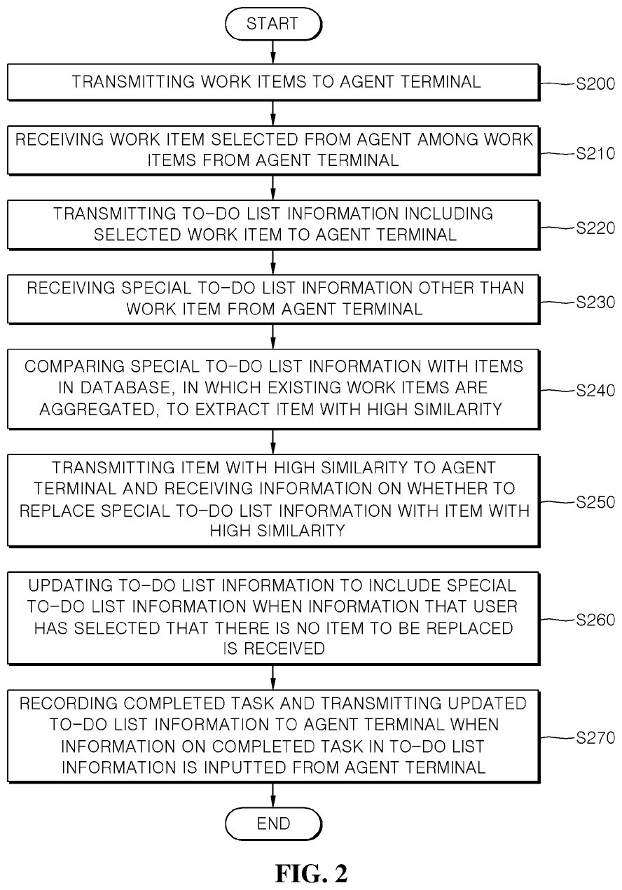

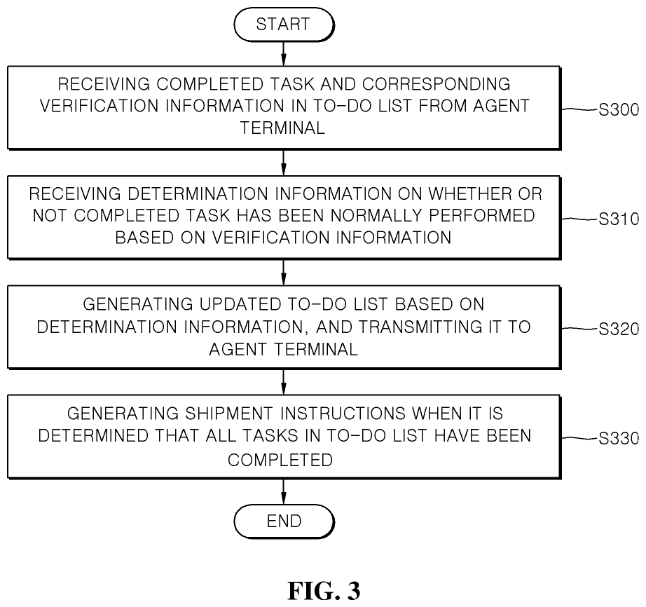

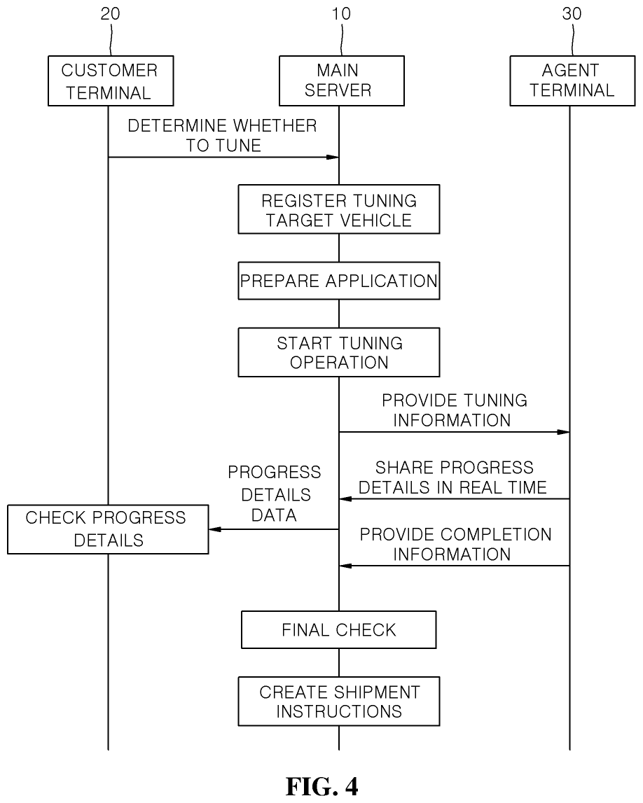

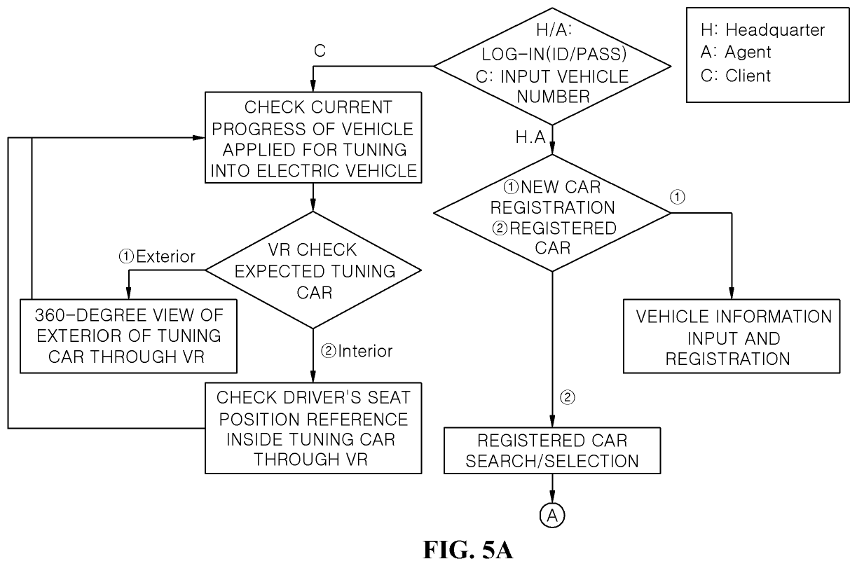

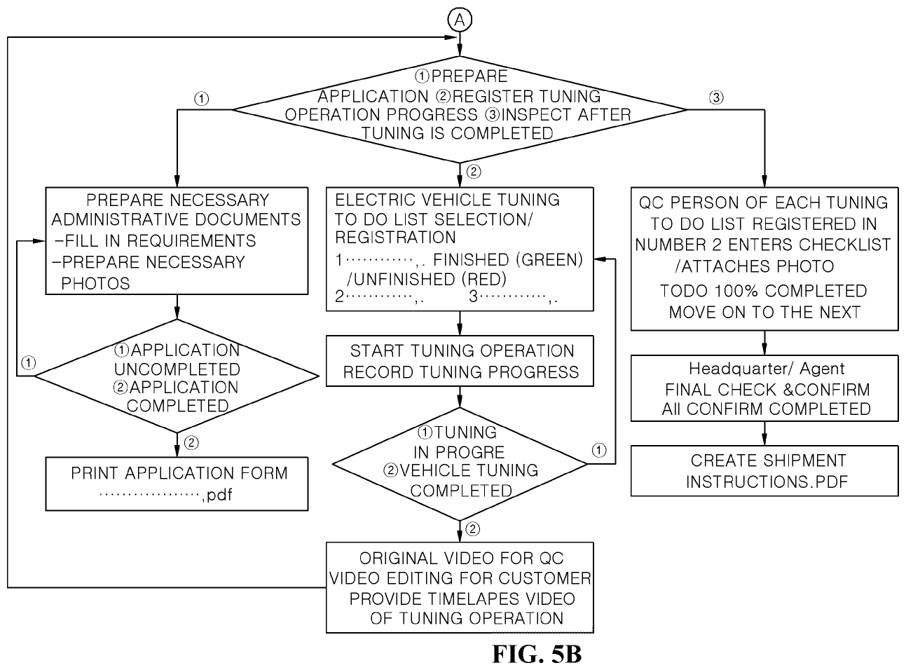

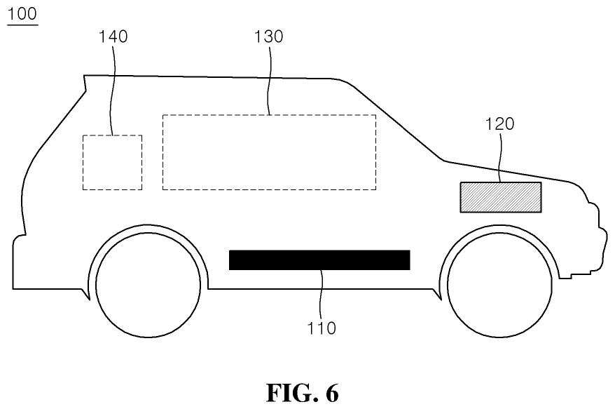

FIG. 1 is a flowchart of a method for providing tuning progress information according to an embodiment of the present disclosure. FIG. 2 is a flowchart of a method for managing a tuning task according to an embodiment of the present disclosure. FIG. 3 is a flowchart of a method for managing tuning task quality according to an embodiment of the present disclosure. FIG. 4 is a diagram illustrating that a tuning progress information provision method, a tuning task management method, and a tuning task quality management method according to an embodiment of the present disclosure are performed in a main server, a customer terminal, and an agent terminal. FIG. 5 is a flowchart schematically illustrating that a tuning progress information provision method, a tuning task management method, and a tuning task quality management method according to an embodiment of the present disclosure are performed. FIG. 6 is a diagram schematically illustrating that respective components are displayed on a display with different display features in tuning progress information provision method according to an embodiment of the present disclosure.

FIG. 1 is a flowchart of a method for providing tuning progress information according to an embodiment of the present disclosure. The tuning progress information provision method according to an embodiment of the present disclosure includes: a step of receiving information related to a tuning target vehicle 100 from a customer terminal 20 (S100); a step of specifying the tuning target vehicle 100 from the received information (S110); a step of specifying tuning target parts for the tuning target vehicle 100 (S120); a step of specifying an agent terminal 30 performing tuning for the specified tuning target vehicle 100 (S130); a step of receiving progress information related to the tuning progress details from the specified agent terminal 30 (S140); a step of classifying the tuning target parts into a first component for which tuning has been completed, a second component for which tuning is in progress, and a third component for which tuning has not been started, based on the received progress information (S150); and a step of displaying the first component, the second component, and the third component with different display features on a display (S160).

In the tuning progress information provision method, the tuning task management method, and the tuning task quality management method according to an embodiment of the present disclosure, the role of a comprehensive tuning management platform is performed through a main server 10, the customer terminal 20, and the agent terminal 30 in performing a tuning task of tuning an internal combustion engine vehicle to an electric vehicle.

In addition, the tuning progress information provision method according to an embodiment of the present disclosure has an effect that a customer can easily register a vehicle, manage the registered vehicle through a database, and easily apply for a necessary part.

Specifically, in the tuning progress information provision method according to an embodiment of the present disclosure, the information related to the tuning target vehicle 100 may be at least one of a vehicle number, a vehicle identification number, and owner information. The main server 10 receives information for tuning progress, such as a vehicle number, a vehicle identification number, owner information, ID and personal information of a requesting customer, payment information, and a part desired to be tuned, from the customer terminal 20, and manages the collected information as a database.

Therefore, when a request for tuning another vehicle of a previously registered customer or a request for re-tuning of a tuned vehicle is received, the tuning task may be processed more quickly, and when re-tuning, efficient tuning operation may be performed by checking the tuning details. In addition, from the customer's point of view, it is convenient since he/she can easily apply for or check it through the customer terminal 20.

FIG. 6 is a diagram schematically illustrating that respective components are displayed with different display features on a display, in a tuning progress information provision method according to an embodiment of the present disclosure. In the tuning progress information provision method according to an embodiment of the present disclosure, the different display features may be expressed in such a way that the first component is displayed in a color-filled state, the inside of the second component is displayed so that a color-filled state and a transparent state are alternately repeated, and the inside of the third component is displayed in a transparent state.

Specifically, based on the information related to the tuning target vehicle received from the customer terminal, the tuning target vehicle 100 is specified, and then a tuning target part to be tuned in the target vehicle is specified. Since the tuning target vehicle 100 is an internal combustion engine, the engine as the tuning target part will be removed, and a driving unit 120 including a battery 110, a motor, and the like needs to provided for tuning into an electric vehicle. In this case, depending on the needs of the customer, a body structure, a cabin room 130, or a trunk 140 may also be specified as the tuning target part.

For example, when the tuning task is performed by an agent, the customer may check the tuning progress in real time through the display of the customer terminal, or the like. Referring to FIG. 6, since the first component is a part that has been tuned and the battery 110 has been installed on the floor of the vehicle, the battery 110 is displayed, as the first component, with the inside filled with color on the display.

In addition, the second component that is being tuned may be the driving unit 120 in FIG. 6, which is expressed, for simplicity, in diagonal lines filling the inside thereof. However, in an actual display, as described above, it may be expressed in various ways such as being displayed to blink by alternately repeating the color-filled state and the transparent state, displayed to be blurred, or displayed to be shaded.

Meanwhile, in the tuning progress information provision method according to an embodiment of the present disclosure, the step S160 of displaying on a display may be configured to include a mode in which the tuning target vehicle 100 is implemented in a three-dimensional shape when viewed from an external point of view, and a mode in which the tuning target vehicle 100 is implemented in a three-dimensional shape when viewed from an internal point of view.

Specifically, the tuning target vehicle 100 is implemented in a three-dimensional shape through 360-degree cameras, sensors, and the like installed outside and inside the vehicle during tuning, and the implemented three-dimensional shape, the tuning progress, and the like are displayed on the display, allowing the customer to grasp the tuning progress at a glance.

FIG. 2 is a flowchart of a method for managing tuning task according to an embodiment of the present disclosure. The tuning task management method according to an embodiment of the present disclosure includes: a step of transmitting work items to the agent terminal 30 (S200); a step of receiving a work item selected from the agent among the work items from the agent terminal 30 (S210); a step of transmitting To-Do LIST information including the selected work item to the agent terminal 30 (S220); and a step of, when information on a completed task in the To-Do LIST information is inputted from the agent terminal 30, recording the completed task and transmitting updated To-Do LIST information to the agent terminal 30 (S230).

In the tuning task management method according to an embodiment of the present disclosure, the main server 10 transmits the work items received from the customer terminal 20 to the agent terminal 30, and receives a selected work item and a completed task from the agent terminal 30 to quickly synchronize the tuning progress, thereby serving as a communication platform between the customer and the agent.

In addition, the agent terminal 30 is provided in the plural not singular, and therefore a plurality of agents receive the work items through the agent terminal 30 to each select a possible work item, and then the main server 10 receives the selected work item through the agent terminal 30.

Specifically, the To-Do LIST may include a tuning target part, a tuning method, and the like for the tuning target vehicle 100 specified in the tuning progress information provision method. The To-Do LIST may also include basic tuning details, e.g., an engine, a battery, a driving unit, an air conditioning system, a steering system, and the like, for tuning an internal combustion engine vehicle to an electric powered vehicle, and may further include additional tuning details such as a body structure, a vehicle color, and additional options.

Further, the main server 10 may understand the customer's needs (vehicle output, battery capacity, and the like) based on the information received from the customer terminal 20, and accordingly, may include a necessary tuning work, a necessary component, and the like depending on the target performance of the tuning target vehicle 100 in the To-Do LIST information to transmit it to the agent terminal 30.

Meanwhile, in the tuning task management method according to an embodiment of the present disclosure, in the updated To-Do LIST information, the progress level of the work item may be displayed in the form of a traffic light indicating at least one of not in progress and completed.

That is, information such as not in progress, in progress, and completed may be displayed for each work item in the form of a traffic light in the updated To-Do LIST information, and the main server 10 records a completed task and transmits the completed task to the agent terminal 30 or the customer terminal 20.

In addition, the tuning task management method according to an embodiment of the present disclosure further includes: a step of receiving special To-Do LIST information other than the work item from the agent terminal 30 (S230); a step of comparing the special To-Do List information with items in a database, in which existing work items are aggregated, to extract an item with high similarity (S240); and transmitting the item with high similarity to the agent terminal 30, and receiving information on whether to replace the special To-Do LIST information with the item with high similarity (S250).

Specifically, in the step S240 of extracting an item with high similarity in the tuning task management method according to an embodiment of the present disclosure, the similarity determination may be performed by a jacquard similarity measurement method. The jacquard similarity measurement method is a simple similarity calculation method, in which each item is made into binary data of 0 and 1 and then the intersection/union of two vectors is found to determine the similarity.

In addition, an item having high similarity may be extracted through cosine similarity, and the cosine similarity is a method of obtaining a cosine angle from two vector values. This similarity has a value of −1 to 1, and the similarity closer to 1 indicates a positive similarity relationship, and the similarity closer to −1 indicates a negative similarity relationship. Since the cosine similarity calculates the angle between two vectors, the concept of directionality is added, so that it is useful.

On the other hand, in addition to the method of analyzing the similarity based on the word of the component, with the recent advance of an image analysis technique, it may be possible to determine the similarity of the work item by using the image analysis technique. When using this, the main server 10 extracts an item with high similarity by image processing and analyzing the image of the actual component of the vehicle, transmits the extracted result to the agent terminal 30, and based on the corresponding result, receives information on whether to replace it with another similar general tuning item from the agent terminal 30.

In conclusion, through the special To-Do LIST, the main server 10 compiles information on tuning items into a database and accumulates data, thereby expecting an effect of improving the degree of completeness, tuning speed, and the like for tuning task processing.

In addition, the tuning task management method according to an embodiment of the present disclosure may further include a step of, when information that the user has selected that there is no item to be replaced is received in the step S250 of receiving information on whether to replace with the item with high similarity, updating the To-Do LIST information to include the special To-Do LIST information (S260). When information that the user has selected that there is no item to be replaced is received, the corresponding item is added to the existing To-Do LIST information in the database managed by the main server 10 to update the To-Do LIST.

FIG. 3 is a flowchart of a method for managing tuning task quality according to an embodiment of the present disclosure. The tuning task quality management method according to an embodiment of the present disclosure includes: a step of receiving a completed task and corresponding verification information in the To-Do LIST from the agent terminal 30 (S300); a step of receiving determination information on whether or not the completed task has been normally performed based on the verification information (S310); a step of generating an updated To-Do LIST based on the determination information, and transmitting it to the agent terminal 30 (S320); and a step of creating shipment instructions when it is determined that all tasks in the To-Do LIST have been completed (S330).

In the tuning task quality management method according to an embodiment of the present disclosure, when the tuning operation is completed, it is determined whether the tuning has been completed based on the verification information received from the agent terminal 30, and the determination information is updated in the agent terminal 30, so that the agent recognizes whether it has been completed or not.

Specifically, in the tuning task quality management method according to an embodiment of the present disclosure, the verification information is photographic information, and the photographic information may be compared with information in a completed state to calculate similarity, and when the similarity exceeds a preset value, it may be determined that the completed task is normal.

In this case, the main server 10 calculates the similarity by comparing the image of the received verification information with the image of the information in a completed state stored in the database by using the image analysis technique. In this case, in order to prevent miscalculation, it is necessary to provide various completion status information for each vehicle model and each component manufacturer in the database, and information on the previously processed similarity calculation may be made into the database and gradually accumulated to increase the accuracy of the similarity calculation.

On the other hand, in the tuning task quality management method according to an embodiment of the present disclosure, the verification information may be transmitted to the terminal of at least one other agent, and the determination information on whether or not a corresponding task has been normally completed may be received from the terminal of the at least one other agent, and when the determination information from the terminal of the at least one other agent all indicate normal, it may be determined that the completed task has been normally performed.

Specifically, this refers to crowdsourcing, and even when completion information is received by any one agent terminal 30, the completion is checked once again by another agent terminal 30, thereby allowing the information to be shared between the agent terminals 30 and having an effect of increasing the accuracy of determination for the completed task.

For communication between the plurality of agents during the above process, the tuning task quality management method according to an embodiment of the present disclosure may be configured to provide a dialogue box between the terminal of the at least one other agent and the agent terminal 30 at the request of the at least one other agent.

In addition, in the updated To-Do LIST in the tuning task quality management method according to an embodiment of the present disclosure, the progress level of the quality management determination of the completed task may be displayed in the form of a traffic light indicating any one of unchecked, passed, and failed. In addition to the progress level, such as unchecked, passed, or failed, of the quality management determination of the completed work in the updated To-Do LIST, an improvement, an additional opinion, or the like may be transmitted to the agent terminal 30 together.

FIG. 4 is a diagram illustrating that a tuning progress information provision method, a tuning task management method, and a tuning task quality management method according to an embodiment of the present disclosure are performed in the main server 10, the customer terminal 20, and the agent terminal 30. FIG. 5 is a flowchart schematically illustrating that a tuning progress information provision method, a tuning task management method, and a tuning task quality management method according to an embodiment of the present disclosure are performed.

The tuning task management method according to an embodiment of the present disclosure is a method of managing a tuning task by the main server 10 capable of communicating with the customer terminal 20 and the agent terminal 30. The customer terminal 20 transmits a decision on whether to tune or not to the main server 10, and when tuning is determined, the main server 10 sequentially performs tuning target vehicle registration, application preparation, and tuning operation start, and then transmits tuning information to the agent terminal 30.

Thereafter, the agent terminal 30 receiving the tuning information transmits tuning progress details to the main server 10 in real time, and when tuning is completed, transmits the completion information to the main server 10. The main server 10 transmits tuning progress details data to the customer terminal 20, and when receiving the completion information, finally checks the tuning items to create shipment instructions if there is no problem, thereby finishing the tuning management task.

In addition, FIG. 5 shows a model in which the tuning progress information provision method, the tuning task management method, and the tuning task quality management method according to an embodiment of the present disclosure are combined. Here, the main server 10 is denoted as a headquarter H, the customer terminal 20 is denoted as a client C, and the agent terminal 30 is denoted as an agent A to briefly indicate that each step is performed.

In conclusion, in the tuning progress information provision method, the tuning task management method, and the tuning task quality management method according to an embodiment of the present disclosure, the tuning progress of a tuning vehicle may be transmitted to the customer terminal 20 through a VR function, and the main server 10 may create an application form in pdf format based on the received application request and tuning vehicle information, or may create shipment instructions in pdf format based on the tuning completion information, and the agent terminal 30 may transmit a time-lapse image of the tuning progress to the main server 10, thereby realizing a comprehensive tuning task management platform where various functions are performed.

Although the embodiments of the present disclosure have been described above in more detail with reference to the accompanying drawings, the present disclosure is not necessarily limited to these embodiments, and various modifications may be made without departing from the technical spirit of the present disclosure. Accordingly, the embodiments disclosed herein are intended to explain, not to limit the technical spirit of the present disclosure, and the scope of the technical spirit of the present disclosure is not limited by these embodiments. Therefore, it should be understood that the embodiments described above are illustrative in all respects and not restrictive. The protection scope of the present disclosure should be construed by the following claims, and all technical ideas within the equivalent range should be construed as being included in the scope of the present disclosure.

[Reference Sign List]

| | |
|---|---|
| 10: main server | 20: client terminal |
| 30: agent terminal | 100: tuning target vehicle |
| 110: battery | 120: driving unit |
| 130: cabin room | 140: trunk |

What is claimed is:

1. A method for providing tuning progress information, comprising:
receiving information related to a tuning target vehicle from a customer terminal;
specifying a tuning target vehicle from the received information;
specifying tuning target parts for the tuning target vehicle;
specifying an agent terminal performing tuning for the specified tuning target vehicle;
receiving progress information related to tuning progress details from the specified agent terminal;
classifying the tuning target parts into a first component for which tuning has been completed, a second component for which tuning is in progress, and a third component for which tuning has not been started, based on the received progress information; and
displaying the first component, the second component, and the third component with different display features on a display.

2. The method of claim 1, wherein the information related to the tuning target vehicle is at least one of a vehicle number, a vehicle identification number, and owner information.

3. The method of claim 1, wherein as for the different display features, the inside of the first component is displayed in a color-filled state, the inside of the second component is displayed so that a color-filled state and a transparent state are alternately repeated, and the inside of the third component is displayed in a transparent state.

4. The method of claim 1, wherein said displaying on a display is configured to include a mode in which the tuning target vehicle is implemented in a three-dimensional shape when viewed from an external point of view, and a mode in which the tuning target vehicle is implemented in a three-dimensional shape when viewed from an internal point of view.

5. A method for managing a tuning task, comprising:
transmitting work items to an agent terminal;
receiving a work item selected from an agent among the work items from the agent terminal;
transmitting To-Do LIST information including the selected work item to the agent terminal; and
recording, when information on a completed task in the To-Do LIST information is inputted from the agent terminal, the completed task and transmitting updated To-Do LIST information to the agent terminal.

6. The method of claim 5, wherein in the updated To-Do LIST information, a progress level of the work item is displayed in the form of a traffic light indicating at least one of not in progress and completed.

7. The method of claim 5, further comprising:
receiving special To-Do LIST information other than the work item from the agent terminal;
comparing the special To-Do LIST information with items in a database, in which existing work items are aggregated, to extract an item with high similarity; and
transmitting the item with high similarity to the agent terminal, and receiving information on whether to replace the special To-Do LIST information with the item with high similarity.

8. The method of claim 7, wherein in said extracting an item with high similarity, similarity determination is performed by a jacquard similarity measurement method.

9. The method of claim 7, further comprising:
updating the To-Do LIST information to include the special to-do list information, when information that a user has selected that there is no item to be replaced is received in said receiving information on whether to replace the special To-Do LIST information with the item with high similarity.

10. A method for managing tuning task quality, comprising:
receiving a completed task and corresponding verification information in To-Do LIST from an agent terminal;
receiving determination information on whether or not the completed task has been normally performed based on the verification information;
generating an updated To-Do LIST based on the determination information, and transmitting it to the agent terminal; and
creating shipment instructions when it is determined that all tasks in the To-Do LIST have been completed.

11. The method of claim 10, wherein the verification information is photographic information, and the photographic information is compared with information in a completed state to calculate similarity, and when the similarity exceeds a preset value, it is determined that the completed task is normal.

12. The method of claim 10, wherein the verification information is transmitted to a terminal of at least one other agent,
determination information on whether or not a corresponding task has been normally completed is received from the terminal of the at least one other agent, and
when the determination information from the terminal of the at least one other agent all indicate normal, it is determined that the completed task has been normally performed.

13. The method of claim 12, wherein a dialogue box can be created between the terminal of the at least one other agent and the agent terminal by a request of the at least one other agent.

14. The method of claim 10, wherein in the updated to-do list, a progress level of quality management determination of the completed work is displayed in the form of a traffic light indicating any one of unchecked, passed, and failed.
